(19) United States
(12) Patent Application Publication
(10) Pub. No.: US 2013/0159194 A1
(43) Pub. Date: Jun. 20, 2013

(54) SYSTEMS AND METHODS FOR AUTHENTICATING BENEFIT RECIPIENTS

(71) Applicant: VoiceTrust IP GmbH, Zurich (CH)

(72) Inventor: Tariq Habib, Toronto (CA)

(73) Assignee: VoiceTrust IP GmbH, Zurich (CH)

(21) Appl. No.: 13/714,844

(22) Filed: Dec. 14, 2012

Related U.S. Application Data
(60) Provisional application No. 61/570,610, filed on Dec. 14, 2011.

(51) Int. Cl. G06Q 20/40

(52) U.S. Cl. CPC G06Q 20/40145
USPC 705/66; 705/39

(57) ABSTRACT

Remote authentication that allows a previously enrolled individual to be remotely authenticated and provided with a benefit from a first party payor through a third-party agent. Remote authentication may include biometric authentication including voice biometric authentication. Use of an authorization token to prove current eligibility to receive a benefit transfer from a third-party agent that is not going to perform an independent biometric authentication. Processes for beneficiaries with a bank account and those without a bank account are disclosed.

### CROSS-REFERENCE TO RELATED APPLICATIONS

This application claims priority to and the benefit of U.S. Provisional Application Ser. No. 61/570,610, filed on Dec. 14, 2011, which is hereby incorporated herein by reference in its entirety.

### FIELD OF THE INVENTION

Embodiments of the invention relate generally to the remote authentication of individuals, and, more specifically, to processes and supporting systems that allow individuals to be remotely authenticated such that they can securely receive benefits through a third-party agent.

### SUMMARY OF THE INVENTION

Various embodiments of the invention provide methods and supporting systems that facilitate the secure transfer of benefits among parties to a benefit transaction. In many instances, benefit programs comprise an ongoing series of payments or transfers over extended periods of time. These transfers are meant to be distributed to an authorized individual (referred to herein as the primary recipient), or, in some cases, their designee. Certain transfers are meant to recur on a periodic basis (e.g., monthly, annually) but are also meant to terminate with the designated recipient either no longer qualifies for the benefit (e.g., unemployment or disability payments), the benefit has been exhausted (payments from a pension or retirement account such as an IRA) or the recipient has died (such as social security). In some cases, the primary recipient may designate an alternate recipient (a trustee or guardian) or identify a particular destination for the benefit such as a bank account. In each case, both the primary recipient as well as any designated recipients must be authenticated in order to permit the distribution of a benefit amount. Such authentication should occur periodically in order to ensure the benefit is being sent to the correct individual, and to reduce fraud.

Examples of such arrangements often occur in the context of a government or analogous organization paying long-term benefits to a qualified beneficiary. In many instances the flow of periodic benefit payments is supposed to stop once the beneficiary dies or possibly moves out of the jurisdiction. Such payments re referred to herein as government-to-person payments (G2P), and may include social transfers as well as wage and pension payments. There are numerous other examples of financial benefit arrangements where an insurance company, trustee, financial aid office, or other similar entity provides periodic payments and/or benefits to an individual and authentication of that individual. The systems and methods described herein are equally as applicable in each such environment.

For some G2P plans, before paying out social benefits like pensions, unemployment compensations, and income support allowance etc. payer (governments and/or other organizations) sometimes check whether beneficiary (the authorized person) is still alive and staying in the country (or other governmental boundary). Conventional methods require the beneficiary to travel long distances in order to be authenticated face-to-face for each payment. This labor intensive process requires a number of brick and mortar facility to receive and process a queue of beneficiaries. All in all, this face-to-face process incurs significant costs for payers while also being extremely inconvenient to the beneficiaries especially for beneficiaries that are elderly or partially disabled.

However, there are numerous methods for authenticating persons using biometric characteristics such as fingerprinting, facial recognition, and retinal scanning one such method that has become useful in remote user authentication is the use of voice recognition. In general voice recognition stores samples of a user's voice and compares subsequently received voice data to the stored sample to determine if they match. Specific techniques for using voice recognition to authenticate individuals are described in greater detail in co-pending, commonly owned U.S. patent application Ser. Nos. 11/416,793, entitled “Speaker Authentication in a Digital Communications Network”, 11/482,549, entitled “Robust Speaker Recognition” and 12/530,883, entitled “Digital Method and Arrangement for Authenticating a Person” each of which is incorporated herein by reference.

Specifically, voice authentication systems can be distinguished as either text-dependent systems or text-independent systems. In text dependent systems, the system prompts a speaker to repeat a predetermined text sample after claiming his identity. However, such systems suffer from the problem that an imposter is able to secretly record a speaker during accessing a voice protected service, and then to misuse the recorded voice sample for accessing the voice protected service by claiming to be the speaker from which the voice sample has been recorded. Text independent systems alleviate this problem as they do not have any text related constraints and allow free text to be used.

Therefore, in one aspect, the invention provides a system for utilizing voice recognition to permit a primary recipient of a benefit from a payor entity to receive the benefit, and, if desired, designate an alternative recipient and/or destination for the benefit. More specifically, the system includes a storage server for storing in a physical memory sets of baseline biometric files, each set of baseline biometric files being captured during an enrollment process and associated with a set of qualified recipients (including a primary recipient) of a series of benefit transfers from a payor. The set of baseline biometric files includes comprises a voice print for use in voice authentication of the qualified recipients. The system also includes a processor for executing stored computer-executable instructions that, when executed implement a voice authentication engine that: (i) compares a current voice print obtained from a recipient requesting authorization and access to at least one of the series of benefit transfers with the biometric baseline file for requesting recipient, and (ii) upon determining the current voice print matches with the biometric baseline file associate with the requesting recipient within an acceptable threshold, creates an authorization token comprising an authorization code and communicate the authorization token to the requesting recipient. In some embodiments, the authorization token and/or code may expire after a specific time period such that the expired authentication code cannot be used to obtain a benefit transfer after expiration.

In some implementations, the system also includes additional computer-executable instructions that, when executed on the processor implement a payment authorization module that: (i) receives a request from a remote agent for approval for payment (or, in some cases, partial payment) of at least one of the benefit transfers to the requesting recipient, the request including the authorization token, and (ii) authorize transfer of funds to the remote agent pursuant to the benefit transfer if the authorization token is confirmed as authentic.

In some embodiments, the biometric baseline file for the requesting recipient is associated with a parameter that uniquely identifies a mobile telephone used by the particular recipient for voice authentication. In such cases, the authorization token may communicated to the requesting recipient by sending the authentication token to a mobile telephone associated with the recipient. In other embodiments, the remote agent comprises an automated teller machine that receives the authentication code from the requesting recipient seeking payment of the funds that originate from the payor and the payment authorization module authorizes the transfers for the requesting recipient to an entity that operates the automated teller machine. In other implementations, the remote agent may be a third party account administrator or account holder acting on behalf of the requesting recipient. In such cases, the payment authentication module may reserve a portion of the benefit for payment to the third party account holder as compensation for facilitating the transfer of funds to the requesting recipient.

The set of qualified recipients may, in some cases, include one or more alternative recipients, and in instances in which the requesting recipient is identified as an alternative recipient, payment of the benefit may be made directly to the alternative recipient. The payment authorization module may further determine whether the requesting recipient has become and/or remains eligible to receive the benefit, and may also check to ensure that the requesting recipient has not already obtained a benefit transfer which precludes obtaining the requested benefit transfer.

In another aspect, a method for authenticating the identity of a recipient of a benefit from a payor includes providing a storage server for storing sets of baseline biometric files and a set of computer-executable instructions, that when executed by a processor, authenticates a requestor. More specifically, each set of baseline biometric files is captured during an enrollment process and associated with a set of qualified recipients of a series of benefit transfers from the payor. The set includes a primary benefit recipient, and, in some instances, may also include one or more alternative recipients. The baseline biometric files include a voice print for use in voice authentication of the qualified recipients. The voice print may be comprised of specific text designated at the time of enrollment, or, in other cases, random text phrases. When executed by a processor, the computer-executable instructions compare a current voice print obtained from a recipient requesting authorization and access to the benefits with the biometric baseline file for the requesting recipient. Upon determining the current voice print matches with the biometric baseline file associate with the requesting recipient within an acceptable threshold, an authorization token is created which comprises an authorization code, and the token is communicated to the requesting recipient.

The computer-executable instructions, when executed, may also receive a request from a remote agent for approval for payment (or partial payment) of a benefit transfers to the requesting recipient, wherein the request includes the authorization token, and authorize transfer of funds to the remote agent pursuant to the benefit transfer if the authorization token is confirmed as authentic.

In some instances, the remote agent is an automated teller machine that receives the authentication code from the requesting recipient seeking payment of the funds that originate from the payor and authorizing the transfer for the requesting recipient to an entity that operates the automated teller machine. In other cases the remote agent may be a third party account administrator or holder acting on behalf of the requesting recipient. In some instances, a portion of the benefit may be reserved for payment to the third party account holder as compensation for facilitating the transfer of funds to the requesting recipient.

In some embodiments, the biometric baseline file for the requesting recipient is associated with a parameter that uniquely identifies a mobile telephone used by the particular recipient for voice authentication. In such cases, the authorization token may communicated to the requesting recipient by sending the authentication token to a mobile telephone associated with the recipient. In other embodiments, the remote agent comprises an automated teller machine that receives the authentication code from the requesting recipient seeking payment of the funds that originate from the payor and the payment authorization module authorizes the transfers for the requesting recipient to an entity that operates the automated teller machine. In other implementations, the remote agent may be a third party account administrator or account holder acting on behalf of the requesting recipient. In such cases, the payment authentication module may reserve a portion of the benefit for payment to the third party account holder as compensation for facilitating the transfer of funds to the requesting recipient.

The set of qualified recipients may, in some cases, include one or more alternative recipients, and in instances in which the requesting recipient is identified as an alternative recipient, payment of the benefit may be made directly to the alternative recipient. The payment authorization module may further determine whether the requesting recipient has become and/or remains eligible to receive the benefit, and may also check to ensure that the requesting recipient has not already obtained a benefit transfer which precludes obtaining the requested benefit transfer.

In some cases, when it is determined that the current voice print does not match the biometric baseline file associate with the requesting recipient within an acceptable threshold, the requesting recipient is transferred to or connected with telephone a call center via telephone. In such cases, the baseline biometric files may comprise one or more text-dependent phrases and the requesting recipient provides a voice sample including the text-dependent phrase(s) as well as additional phrases intermixed within the text-dependent phrase(s). The text-dependent phrases may be extracted from the additional phrases and compared the extracted text-dependent phrase to the baseline biometric files. In some embodiments, the additional phrases are compared to the text-dependent phrases to confirm speaker consistency throughout the received voice sample.

In yet another aspect, a method for validating the identity of a recipient of a benefit payment from a payor includes receiving via a telephone network, a voice sample of the recipient and storing the received voice sample in a data storage server. While in the presence of the recipient, an agent of the payor confirms the identity of the recipient and sends a message to the data storage server that includes a mobile telephone number registered to the recipient. An automated call is initiated to the mobile telephone number registered to the recipient and a second voice sample of the recipient is captured while the recipient is in the presence of the agent of the payor. A unique identifier is sent to the mobile telephone number registered to the recipient, and a message is received that includes the unique identifier from the agent of the payor.

In another aspect of the invention, a system for remotely enrolling a recipient of a benefit payment with a system for validating the recipient's identity an authorizing payment to the recipient includes a processor for executing computer-executable instructions and memory for storing the computer readable instructions, that when executed by the processor implements an application operational on a mobile computing device. The application allows a user of the mobile computing device to enter a unique identification number (e.g., a social security number, telephone number, account number, etc.) associated with an intended recipient of a benefit payment, record a voice sample of the intended recipient of the benefit payment, and transmit the unique identification number and voice sample from the mobile computing device to a central server, thus enrolling the intended recipient as an authorized recipient of benefit payments. The voice sample may be text-specific spoken phrases, or, in other instances, random text independent phrases.

In other aspects In another aspect, the invention provides software in computer-readable form for performing the methods described herein.

Other systems, methods, features and advantages of the disclosed teachings will be or will become apparent to one with skill in the art upon examination of the following figures and detailed description. It is intended that all such additional systems, methods, features and advantages be included within the scope of and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 illustrates the various entities and process flows related to the enrollment of an authorized recipient in a system in accordance with various embodiments of the invention.

FIG. 2 further illustrates the provision of a benefit to a recipient via a third party in accordance with various embodiments of the invention.

FIG. 3 illustrates the processes of FIGS. 1 and 2 in which the benefit payments remain locked pending authentication of the recipient in accordance with various embodiments of the invention.

FIG. 4 illustrates an alternative implementation of an authorization process for delivering a benefit from a payor through an agent in accordance with various embodiments of the invention.

FIG. 5 illustrates how the authorized recipient receives the benefit from the agent in accordance with various embodiments of the invention.

FIG. 6 illustrates an alternative enrollment process in accordance with various embodiments of the invention.

FIG. 7 illustrates another alternative enrollment process in accordance with various embodiments of the invention.

FIG. 8 is a schematic of the various computing components use to implement the processes described herein in and accordance with various embodiments of the invention.

### DETAILED DESCRIPTION

Individuals may receive periodic benefit payments for any number of reasons. For example, a person may receive payments from a governmental agency for unemployment, disability, a pension fund, or even a state lottery. Payments from private institutions are also common, such as privately funded pensions, IRAs, annuities, reverse mortgages, etc. While the details of the underlying legal obligations and structure of the agreements that create the payment obligations is not germane to the scope of the invention, there are commonalities throughout each. Generally, a payor (e.g., a bank, government agency, investment advisor, trustee, etc.) makes periodic transfers of some benefit (typically money, but in some cases stored value credits, food stamps, healthcare payment credits or other similar benefits) to particular beneficiary, referred to herein as a “primary recipient.”

While the range of possible uses for the teachings of the present disclosure is extensive, a set of implementations is provided below for exemplary purposes only.

| Payor | Recipient | Transferred Benefit | Agent |
|---|---|---|---|
| Pension provider | Retired person that | Money | Bank, grocery store |
| including both | qualifies for a | | |
| government and | pension | | |
| private pensions. | | | |
| Emergency | Person displaced by | Direct payment to | Front desk staff at |
| Management Service | disaster such as | hotel for lodging | hotel or motel. |
| such as FEMA, Red | flooding, hurricane, | with a not to exceed | |
| Cross, Red Crescent | for an extended time. | per diem | |
| or insurance | | | |
| company | | | |
| Government or | Employee on | Direct payment to | Front desk staff at |
| company | business trip | hotel for lodging | hotel or motel. |
| | including military | with a not to exceed | |
| | personnel staying in | per diem | |
| | civilian lodging while | | |
| | traveling | | |
| Emergency | Person displaced by | Direct payment to | Front desk of a |
| Management Service | disaster such as | restaurant for food | restaurant. |
| such as FEMA, Red | flooding, hurricane, | for displaced person | |
| Cross, Red Crescent | earthquakes | or family. | |
| or insurance | | | |
| company | | | |
| Government or NGO | Person entitled to | Food rations and | Distribution |
| entity | disaster relief | other related items, | warehouse that |
| | | such as fuel for | distributes rations |
| | | cooking, soap for | and gets bulk |
| | | washing etc. | transfers of resources |
| | | | such as by the truck |
| | | | load. |
| Government or NGO | Refugee or other | Monetary benefit | Any facility with |
| entity | displaced person | | adequate funds on |
| | | | hand to distribute |
| | | | funds to many |
| | | | refugees or displaced |
| | | | persons. |
| Government Program | Person needing a | Controlled substance | Pharmacy or clinic. |
| or Insurance | pharmaceutical that is | | |
| Company | a controlled | | |
| | substance such as | | |
| | methadone for | | |
| | treatment of drug | | |
| | additions or a | | |
| | narcotic for pain | | |
| National Identity | All Citizens and/or | Identification | Satellite Offices of |
| Programs | authorized non- | including the | the Identification |
| | citizens | issuance of | Program |
| | | identification | |
| | | documents | |
| Remote Voting | Eligible Voters | Ability to Vote | Locations designated |
| Program | | | by the Government, |
| | | | including locations |
| | | | such as polling |
| | | | stations, homes, |
| | | | offices, embassies, |
| | | | consulates. |

In each case, the process of receiving benefits can be described as two independent but related processes—an initial eligibility/enrollment process and a benefit receipt process. The initial enrollment process establishes the recipient's eligibility to receive periodic transfers and captures important identification facts about the recipient. Such information may include, for example, date of birth, employment history, military service, disability or illness status, marriage status, facts about a spouse that may be relevant to becoming eligible for benefits such as survival benefits, qualification for the payout from a class action lawsuit, proof of residency or citizenship, status as a beneficiary under a trust or will, as well as other facts.

Once the recipient has been qualified as eligible for the benefit, the person may receive benefit, typically as a transfer of funds from the payor. As will be described in greater detail below, the funds may be delivered directly to the recipient, to a trustee or bank account, or to an authorized third party, referred to herein as an “alternative recipient.”

For subsequent benefit receipts/transfers, the facts needed for proof of initial eligibility need not be recaptured, but certain key pieces of information may be required for verification purposes. For example, to receive subsequent benefit transfers, the recipient may need only to provide minimal authentication data to confirm that benefit transfer is actually being requested by and sent to the recipient that was previously qualified to receive benefit transfers under this program. This subsequent (and, in some cases periodic) proof of identity confirms that the recipient is still alive and authorizes payment of the benefit, as many benefit programs cease when the beneficiary dies. Thus, proof of life is important in a process to release the next benefit transfer.

As noted above, a prior art process for handling authentication of identity for subsequent benefit transfers was to travel to a facility run directly or indirectly by the payor for a face-to-face authentication, perhaps augmented by presentation of identification documents such as driver licenses or other government issued identification. This process would be repeated for each and every benefit transfer. For a benefit transfer made once a year, this process may have been tolerable, but for a process that has periodic benefit transfers this process was less than ideal.

An improved system allows the subsequent authentication of identity of a previously qualified individual to be performed remotely through the use of one or more biometric identifiers. Biometric identifiers include physiological and biological characteristics. Physiological characteristics are related to the shape of the body, and include but are not limited to: fingerprint, face recognition, DNA, palm print, hand geometry, iris recognition (which has largely replaced retina), and odor/scent. Behavioral characteristics are related to the behavior of a person, including but not limited to: typing rhythm, gait, and voice. Some researchers have coined the term “behaviometrics” to describe the latter class of biometrics.

In various embodiments of the present invention, systems and methods for enrolling and/or authorizing payments to or on behalf of a recipient use voice authentication as the biometric identifier. During the process of initial qualification as eligible for a periodic benefit transfer, the recipient may be asked to speak a series of words (a “baseline” biometric sample) into a device that records the sound of the recipient speaking those particular words. This initial voice sample is used as the “baseline” to which subsequent voice samples are to be compared. In some instances the specific words or phrases may be the same (i.e., text dependent) during enrollment and during subsequent requests, whereas in other cases the words or phrases may be different (text independent). In certain instances, a combination of the two may be used, wherein the recipient speaks specific phrases during enrollment, and other phrases to initiate payment requests, with an overlap of phrases (which may or may not be known to the recipient) between the two voice samples.

When the recipient seeks receipt of subsequent benefit payments, the recipient contacts the payor or the payor designee to request payment. The contact may be through a mobile telephone or other telephone network to a specific number or to a designated system employed by or operated on behalf of the payor. By using the telephone, the authentication can be done remotely, from any location and at any time, as selected by the recipient, as opposed to the location and hours set by the payor. The telephone call is routed to a voice authentication system where the system compares the current voice sample to the baseline biometric and determines the likelihood that the newly received sample matches the baseline. In some instances, additional information may be captured and used to adjust the computed likelihood, such as emotional characteristics of the voice sample (e.g., speaking quickly or unnecessarily slowly, or the detection of stress). If the likelihood of a match is above a certain threshold (or the likelihood of a mismatch us below a certain threshold) the recipient is authenticated and the next benefit transfer is provided to the recipient.

End users (e.g., pensioners or other type of welfare payments beneficiaries) can interact with the system through a normal phone without a special application as all available channels are supported such as SMS text, USSD, data channels, etc.). Though, in some implementations, a specialized mobile application is provided that enhances the fund management and authentication process by utilizing security and control provided by the network, operating system and the mobile app. Digital signatures may also be used to enhance security of the mobile application.

The authentication system can be implemented as standalone application or as a module to a system that provides additional functions such as enrolment, token management, fund management, bookkeeping, account management, card/ATM processing services, mobile number recognition and portability, location-based services, and the like. The system may also be implemented as a series of software modules made available as a service using Internet cloud-based services (e.g., software-as-a-service, or SaaS).

In some cases, the benefit may be paid into an account that is held on behalf of the recipient, and the funds “locked” or otherwise designated as not available for withdrawal until the recipient is authenticated, at which time the funds are unlocked and made accessible to the recipient. In other embodiments, a network of authorized agents may be used to deliver the benefit to the recipient. In such cases a token may be provided to the recipient upon authentication, and the token presented (either physically or electronically) to the agent for payment. The agent can confirm authenticity of the token and release the benefit thereafter. Examples of authorized agents include banks, merchants, hospitals, government agencies, etc.

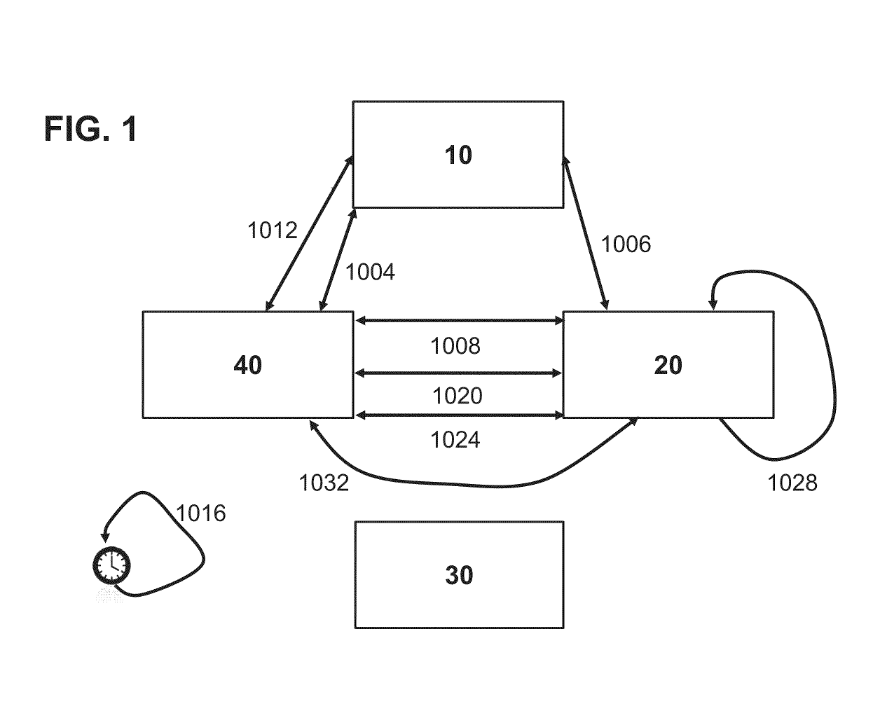

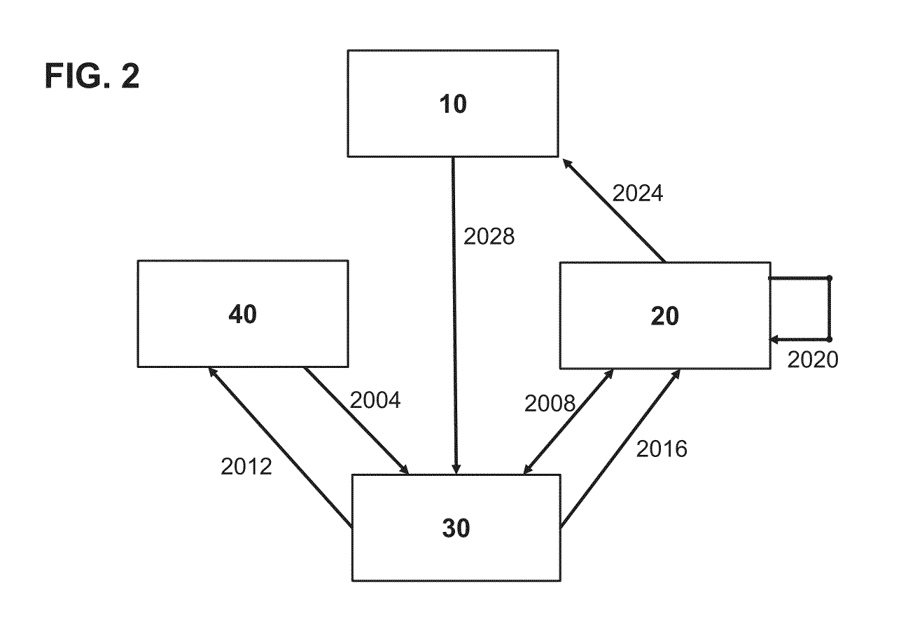

FIG. 1 generally illustrates the environment in which the systems and techniques may be implemented, the primary participants, and the data and information flows among the participants for certain embodiments. Generally, the primary participants include a Payor 10, an Authentication System 20, a Third-Party Agent (“Agent”) 30 and a Recipient (“Recipient”) 40. The process as shown in FIGS. 1 and 2 is a process to authorize a recipient to receive a benefit that originates from a payor but is delivered through an agent using an authorization token.

Initially, Payor 10 establishes that Recipient 40 is eligible to receive repeated benefit transfers under a designated benefit program (STEP 1004). The eligibility process may be straightforward (e.g., such as visiting a government office) whereas in other instances it may be more comprehensive, as described in greater detail. below. The Payor 10 communicates with the Authentication System 20 by providing instructions that Recipient 40 is now eligible for benefits and will be receiving authentication tokens to collect the benefits from a third party. For programs where the amount of benefits or the conditions for receiving benefits differ among recipients, certain details for each Recipient 40 are provided. In the case of a pension or unemployment compensation system, for example, facts such as how much a recipient earned, or how long they were employed may be important. In another example, a mother receiving food stamps may receive a different amount of monthly support than a mother having fewer children.

In one particular example, the Authentication System 20 provides the Recipient 40 with a pair of codes. The first code may be a user code for the Recipient 40 such as a Social Security number or other unique identification number for the Recipient 40. As this identification number may be known to others, the user code may be coupled with a Personal Identification Number (PIN) that is provided to both the Recipient 40 and the Authentication System 20. The two codes may be used for the enrollment process during which a biometric baseline is captured from the Recipient 40. A person presenting both the user code based on a unique identification number and the PIN to be used solely for providing the biometric baseline is unlikely to be an imposter acting without help from the authorized Recipient 40. One of skill in the art will recognize that the Authentication System 20 may also provide the PIN to the Payor 10 to convey to the Recipient 40 or the Authentication System 20 could provide the PIN directly to the Recipient 40. Alternatively, the Payor 10 may issue the PIN to the Recipient 40 and inform the Authentication System 20 of the PIN.

The Recipient 40 then provides an initial biometric baseline to the Authentication System 20 for use in issuing authentication tokens (STEP 1008). In some cases, employees or agents of the Payor 10 may assist the Recipient 40 through the process of providing the initial biometric baseline, either over the phone or in person.

The Payor 10 then provides Recipient 40 with the initial benefit payment (STEP 1012) as the Recipient 40 is present at the Payor's facility. This step is optional as the first benefit payment may be done with the provision of an authorization token and fulfilled at an Agent 30 using the same process as with the subsequent benefit payment. In one particular embodiment, an employee of the Payor 10 helps the Recipient 40 through the first cycle of obtaining an authorization token from the Authentication System 20 and obtaining a benefit payment from an Agent 30 (as described in more detail below).

As time passes, eventually the Recipient 40 seeks the next benefit payment (STEP 1016). Or the first benefit payment, if the Payor did not provide an initial benefit payment at Step 1012. To effect the payment, the recipient 40 engages with the Authentication System 20 (STEP 1020). The Authentication System 20 accesses the previously stored biometric baseline for the requesting Recipient 40 and interacts with the Recipient 40 to solicit and collect a biometric input set which may be compared with the biometric baseline.

The Authentication System 20 compares the submitted biometric input set against the biometric baseline (STEP 1024) to authenticate the Recipient 40. One of skill in the art will understand that authenticate is the outcome when the match of the biometric data is sufficiently strong that the risk that this is an imposter is sufficiently small to be deemed acceptable. The non-zero residual risk may be that the risk is one in a 1000 or one in 10,000 that this is an imposter.

If the match is not sufficient, the test may be repeated by seeking a new biometric sample from the Recipient 40. If after several repeated attempts, authentication is not obtained; the Recipient 40 may be informed that the Recipient 40 will need to go to the Payor 10 to get a new biometric baseline created.

The threshold criteria is configurable and is specific to particular risk profiles set by each Payor. For example, a “combined” score from different voice recognition engine(s) may require that a user be asked to repeat for a certain number of tries. In case of continuous failure (perhaps due to amplitude, background noise etc.) user may instructed to go to the Payor or the call transferred to linked call center agent who can manually ascertain identity of the requesting receiver. If still unsuccessful, then beneficiary contact the Payor to create a new biometric baseline.

In some instances, the system “recreates” the baseline by storing the most recent (or every n^{th}) voice sample as a new baseline. This addresses the “aging” or “maturation” problem introduced as recipients age.

Still referring to FIG. 1, the authentication System 20 checks that the request for benefits is proper (STEP 1028). This may include use of information received from the Payor 10 to confirm that the recipient is still eligible under the program. Eligibility may be communicated in response to a query or may be assumed to be eligible until a notice of non-eligibility is sent from the Payor 10 to the Authentication System 20. The Authentication System 20 may check to ensure that the Recipient 40 has not exhausted the rights to benefit transfer for this particular period to prevent the Recipient 40 from seeking another monthly payment before the end of the month. Alternatively, the step of checking that the request is proper may be done prior to the biometric authentication step.

The Authentication System 20 then sends an authentication token to the Recipient 40 (STEP 1032). The authentication token is typically an electronic token or a one-time password (OTP), which is frequently valid for a limited period of time. The authorization token may be sent by Short Message Service (SMS) communication or by any other communication system including Unstructured Supplementary Service Data (USSD), General Packet Radio Service (GPRS), or others to a mobile device (e.g., phone, or tablet) or via email. The Recipient 40 may request a benefit transfer/payment from an Agent 30.

The System 20 may optionally check for the current presence of the mobile telephone within the jurisdiction of the Payor 10 before granting an authorization token. Some Payor 10 programs may only apply to current residents of a jurisdiction (such as city, county, state, country, or aggregation of counties such as the European Union). Thus, if a qualified Recipient 40, leaves the jurisdiction, the Resident 40 may stop being qualified or at least be temporarily ineligible for certain benefit transfers. Or, in another example, a program that pays for lodging for a qualified Recipient 40 that is traveling on Payor 10 business may check to ensure that the Recipient 40 is at least 50 miles from the Recipient's home before authorizing payment for lodging expenses.

Given that mobile telephone location can be known from an onboard GPS (global positioning satellite) system or can be approximated based upon the known location of a cell phone tower interacting with the Recipient's mobile telephone, it is possible to pass the location of the Recipient's mobile telephone during the request for an authorization token. Thus, the Authentication System 20 may make approval contingent on mobile telephone location and may record the location in the records for that Recipient 40.

Thus, more generally, the Authentication System 20 may require an indication from the telephone communication system (whether from the telephone itself or from one or more communication towers in communication with the Receiver 40) that the Receiver 40 is within an eligible geographic region before issuing an authorization token.

Referring now to FIG. 2, the Recipient 40, no win possession of an authorization token, now travels to or communicates with an Agent 30 and provides the agent with the authentication token (STEP 2004).

The Agent 30 then communicates with the Authentication System 20 to confirm authorization for the benefit transfer (STEP 2008). If the Authentication System 20 authorizes the benefit transfer, the process continues and the Agent effects the transfer to the Recipient 40 (STEP 2012). The transfer may be in the form of direct payment, or in other cases, a deposit to a bank account, credit onto a stored value card, a gift certificate, an online credit at a website, or transfer of physical goods. The Agent 30 then communicates to the Authentication System 20 that the benefit transfer has been made (STEP 2016).

If the Authentication System 20 does not authorize the Agent 30 to make the benefit transfer, the reason for not proceeding is communicated to the Recipient 40 via the Agent 30, the Authentication System 20, or the Payor 10.

The Authentication System 20 updates its records to indicate that the unique authorization token provided to Recipient 40 has been used so that the Recipient 40 may not seek a benefit transfer again using this now exhausted authorization token (STEP 2020). The Authentication System 20 may also update records so that the Recipient 40 may not seek another authorization token until a new period for benefits starts. The Authentication System 20 then communicates with the Payor 10 to provide information sufficient to trigger payment from the Payor 10 to the Agent 30. (STEP 2024). In some cases, the Agent “fronts” the money on behalf of the Payor 10, and is reimbursed at a later time. This may also update the Payor's records on the benefits transferred to this specific Recipient 40 if the Payor 10 keeps long term records of benefits provided to individual program beneficiaries.

Because the Agent 30 pays the Recipient 40, the Payor 10 may provide payment to the Agent 30 for this transaction (STEP 2028). This payment may merely reimburse the Agent 30 for the actual benefit transferred to the Recipient 40, or may also include a service fee in addition to the value of the benefit transferred to the Recipient 40. In the instances where the benefit transferred to the Recipient 40 are physical items such as items of food or medical supplies, the Payor 10 may send physical items to replenish the inventory of the Agent 30 instead of or in addition to reimbursing the Agent 30 for providing the items to the Recipient 40. In some instances, this step may be implemented with the Authentication System 20 acting as an intermediary for the funds transfer so that the operators of the Authentication System 20 actually provide the transfer to the Agent 30 and the Authentication System 20 is reimbursed (either before or after the payment to the Agent 30) by the Payor 10.

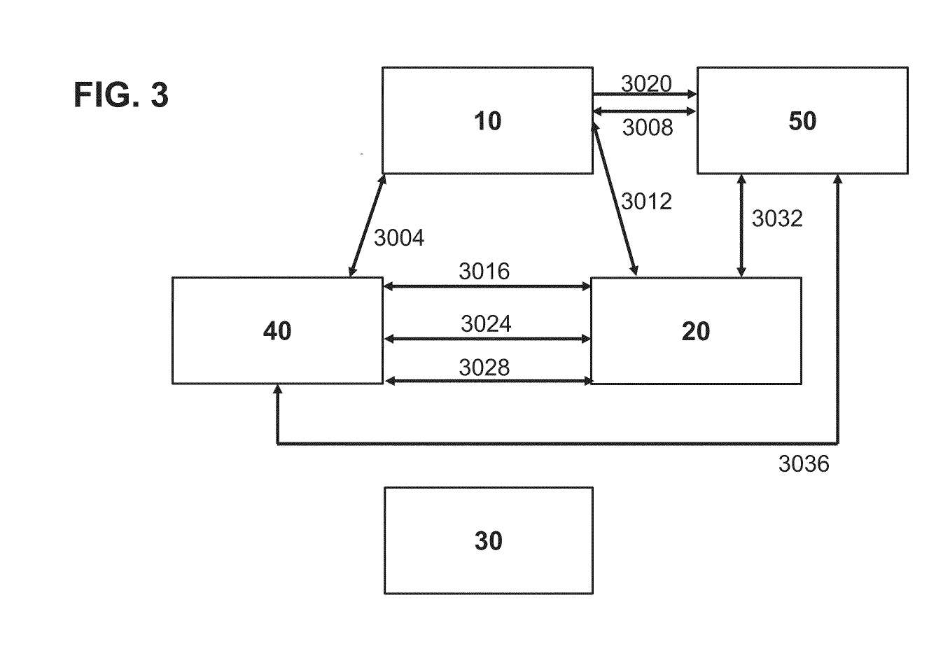

One variation of the process set forth above is to use a bank or other institution that handles funds, including, for example, an entity that issues debit cards or other cards that may be used to purchase goods or services as a conduit for payment of benefits. While there are many similarities to the processes described above, the sequence of events is slightly different as the payor transfers the benefit to an account designated for the recipient by the bank but the funds are locked and cannot be accessed by the recipient until the authorization process is completed. The process is illustrated in FIG. 3.

As in FIG. 1, the Payor 10 establishes that Recipient 40 is eligible to receive repeated benefit transfers under a program (STEP 3004). The Payor 10 then associates an account for use in receiving electronic fund transfers for the benefit of the Recipient 40 (STEP 3008). The account may be an existing account held by the Recipient 40 at a financial institution such as a bank, credit union, or any other institution that allows for the deposit of money and the use of the money, such as PayPal, collectively referred to herein as Bank 50. In some cases, the Payor 10 may work with the Bank 50 and the Recipient 40 to set up an appropriate account for the benefit of the Recipient. In some cases, the Recipient 40 may delegate payment to an account of another person, such as in needing to verify alimony or child support payments, in which case both the Payor 10 and the Recipient 40 are validated.

The Payor 10 notifies the Authentication System 20 that Recipient 40 is now eligible for receipt of benefits (STEP 3012) and provides details of the payment to the Bank 50 such as the account number for the Recipient 40, or other identifying codes unique to a particular Recipient 40 serviced by that Bank 50). As with the prior techniques, the Recipient 40 provides an initial biometric baseline to the Authentication System 20 for use during the authentication process (STEP 3016). In some cases, Payor 10 employees or agents may help the Recipient 40 through the process of providing the initial biometric baseline.

The Payor 10 then transfers money into the Recipient's account at Bank 50 (STEP 3020). However, the money is initially “locked”—meaning the Recipient 40 cannot access or use the money until an authorization process is completed. In some embodiments, the initial benefit transfer may not be locked (or may be instantly unlocked) as the Recipient 40 may have been qualified by the Payor 10 and confirmed their identity such that the Payor 10 is assured that the Recipient 40 is in fact the right person. Likewise, based on the relevant time cycle for this Payor 10 program, subsequent payments may be moved into the Recipient 40 account at the Bank 50 periodically (e.g., weekly, monthly, quarterly, annually, or on demand) and held there as locked. For example, the locked funds may be moved into the Bank 50 and allocated to the Recipient's account once a month.

An exception report may be generated to notify the Payor 10 if a Recipient 40 does not obtain the benefit or full benefit in a given month as this may be an indication that the Recipient 40 is sick, out of the region, or possibly dead. Thus, the exception of not fully claiming the benefit may be relevant to the Payor 10 which may wish to investigate whether the Recipient 40 remains eligible for the benefit. In some cases, Payor 10 may also notify or attempt to notify the Recipient 40 via email, SMS, telephone, or mail to ascertain the status of the Recipient 40.

To request benefit payment, Recipient 40 engages with the Authentication System 20 (STEP 3024). The Authentication System 20 accesses the previously stored biometric baseline for this Recipient 40. The Recipient 40 then provides a biometric input set to the Authentication System 20 which is compared with the biometric baseline (STEP 3028). In some cases, multiple inputs are provided, if, for example, certain samples are of poor quality or do not include the necessary text phrases for comparison to the baseline. Multiple samples may be combined into a single sample prior to the comparison, if need be.

If the match is not sufficient, the test may be repeated by seeking a new biometric sample from the Recipient 40. If after several repeated attempts, authentication is not obtained; the Recipient 40 may be informed that the Recipient 40 will need to physically visit the Payor 10 to get a new biometric baseline created.

Upon successful authorization based upon comparison with the biometric baseline, the Authentication System 20 authorizes the Bank 50 to unlock the funds in the Recipient 40 account (STEP 3032). In this scenario, no token need be provided to the Recipient 40 as the Recipient 40 with a bank account may withdraw money from a teller at the Bank 50, use an ATM machine that can access funds for Bank 50, or possibly use other banking tools such as a debit card or a check (STEP 3036). Thus, as illustrated in FIG. 3, there is no need for Agent 30. The Recipient 40 is now ready to access unlocked funds without the assistance of an Agent 30.

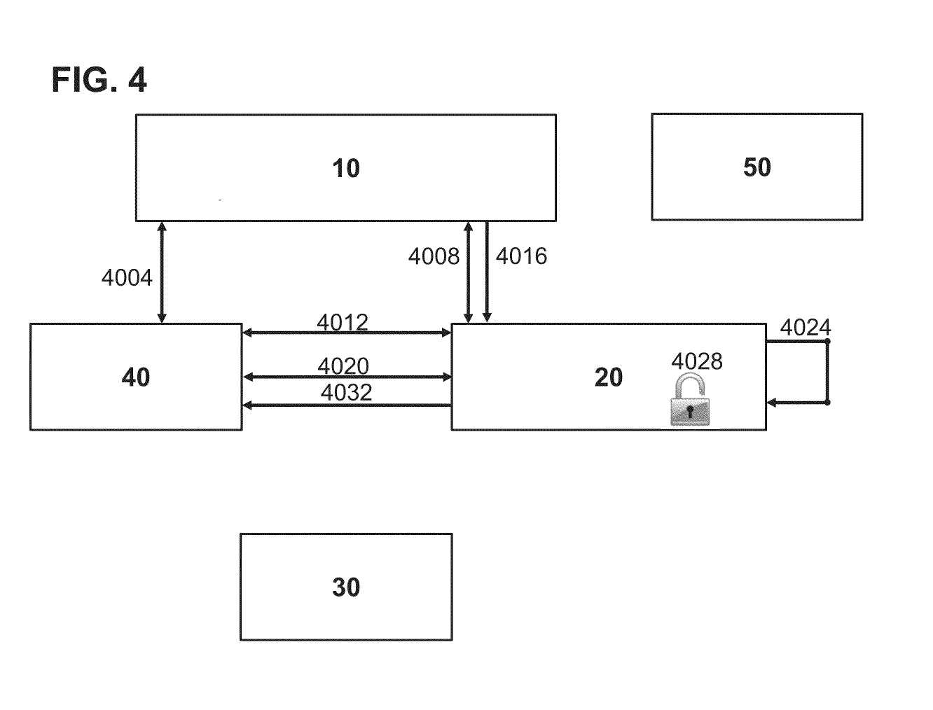

Referring now to FIG. 4, locked funds can also be provided to an “unbanked” Recipient 40 who does not have a relationship with a formal bank or an account into which the funds can be deposited. As with the previously described techniques, Payor 10 establishes that Recipient 40 is eligible to receive repeated benefit transfers under a program (STEP 4004). However, in this embodiment the Payor 10 communicates with Authentication System 20 to set up a virtual account associated with the Recipient 40 (4008). Examples of virtual accounts are commonly referred to a digital wallet. The Recipient 40 provides an initial biometric baseline to the Authentication System 20 for use in issuing authentication tokens (STEP 4012). Again, in some instances Payor 10 employees may help the Recipient 40 through the process of providing the initial biometric baseline.

The Payor 10 transfers money into the Recipient's virtual account at Authentication System 20 (STEP 4016), but the funds are locked pending the presentation of a valid authentication. Likewise, based on the relevant time cycle (or other triggering events) for the particular Payor 10 program, subsequent payments are periodically moved into the Recipient 40 virtual account at the Authentication System 20 and held there as locked. For example, the locked funds may be moved into the Authentication System 20 and into the Recipient's virtual account once a month. As noted above, the failure of a particular Recipient to obtain the full set of benefits in a digital wallet in a timely way may trigger an exception report which identifies the Recipient 40 to the Payor 10 as the failure to claim the full amount of one benefit may indicate a change in the eligibility of the Recipient 40 including that the Recipient 40 may have died.

When Recipient 40 requests a benefit payment, he engages with the Authentication System 20 (STEP 4020). The Authentication System 20 accesses the previously stored biometric baseline for this Recipient 40 and requests that the Recipient 40 provide a biometric input set. The Authentication System 20 then compares the submitted biometric input set against the biometric baseline to authenticate the Recipient 40 (STEP 4024).

If the match is not sufficient, the test may be repeated by seeking a new biometric sample from the Recipient 40. If after several repeated attempts, authentication is not obtained, the Recipient 40 may be requested to visit the Payor 10 to create a new biometric baseline. If the match is sufficient based on the comparison to the baseline file, the Authentication System 20 unlocks the funds in the Recipient 40 virtual account within the Authentication System 20 (STEP 4028). As part of the same authorization sequence, the Authentication System 20 sends an authentication token to the Recipient 40 (STEP 4032). For example, the authorization token may be sent as a text message, email or other message to the mobile telephone of the Recipient 40, and may include an alpha-numeric text string, a bar code, a QR code, or other machine-readable code or codes as an authentication token. With the token in his possession, the Recipient 40 presents the Agent 30 with the token to access the funds.

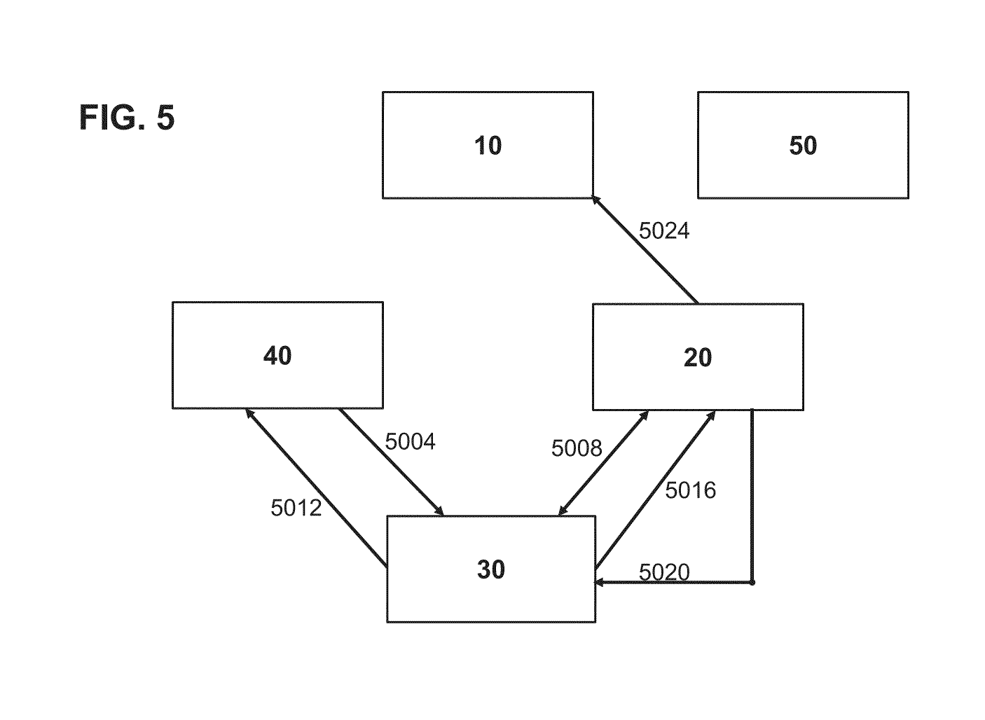

Referring now to FIG. 5, the process for using the token to retrieve the funds is described in greater detail for “unbanked” recipients. The Recipient 40, now having an authorization token, travels to an Agent 30 located somewhere convenient to the Recipient 40 and communicates the content of the authentication token to the Agent 30 (STEP 5004).

The Agent 30 communicates with the Authentication System 20 to confirm authorization for the benefit transfer (STEP 5008). If the Authentication System 20 authorizes the benefit transfer, the process continues. If the Authentication System 20 does not authorize the Agent 30 to make the benefit transfer, the reason for not proceeding is communicated to the Recipient 40 by the Agent 30, the Authentication System 20, or the Payor 10. Possible reasons for denial of the transfer include: the token is fake/unissued, the token has already been used, the token was issued with an expiration date which has passed, and/or the Recipient is no longer eligible for benefits under the Payor's program (e.g., the Recipient passed away between the time the token was issued and its presentation by the Agent 30, a fraud alert was raised related to the particular Recipient, or the Payor has frozen all payments under the particular program).

If the token is accepted, the Agent 30 provides the benefit transfer to the Recipient 40 (STEP 5012). For example, the Agent 30 may provide cash to the Recipient 40 equal to the current pension payment that has been unlocked by the authentication process. In some instances, the Agent 30 provides the benefit transfer to the Recipient 40 less a transaction fee. In this case, because the Agent 30 takes the transaction fee from the payment going to the Recipient 40, there is no need for the Agent 30 to engage with the Payor 10 or the Authentication System 20 to arrange for payment of the service fee. However, in other embodiments the Agent is paid separately by the Payor and/or an administrator of the System 20, either for each transaction, in batch, or for a flat service fee.

Optionally, the Agent 30 communicates to the Authentication System 20 that the benefit transfer has been made (STEP 5016).

The Authentication System 20 then transfers the unlocked funds from the Recipient's virtual account to an account designated for the Agent 30 (STEP 5020). The movement of funds can be done in any of the conventional ways known in the art. In one particular implementation the funds may be moved into the Agent's account prior to the Agent 30 providing the benefit to the Recipient 40. Optionally, failure to confirm transfer of the benefit to the Recipient 40 within an allotted time would cause the Authentication System 20 to reverse the fund transfer.

In some cases, the Authentication System 20 communicates to the Payor 50 that the Recipient 40 has been paid by Agent 30 (STEP 5024). Alternatively, the Payor 10 may receive notice of the Agent 30 to Recipient 40 payment from the Agent 30. Having the Authentication System 20 as the hub for information that may be coming from many different Agents 30 may make the process easier for the Payor 10 as the Payor 10 only needs communications from the Authentication System 20. Again, the Payor 10 may provide a service fee payment to the Agent 30 for this transaction rather than having the Agent 30 withhold a service fee out of the amount provided to the Authentication Service 20 for the Recipient 40.

In some implementations, the interaction with the Agent 30 described in FIG. 5 is effected through the use of an Automated Teller Machine (ATM). The interaction may be implemented so that the ATM machine uses a “no-card interaction” mode. When using the no-card interaction mode, the Recipient 40 approaches the ATM and selects no-card mode. The Recipient 40 does not insert a card into the ATM, but merely communicates his token code either via a keypad or by sending an electronic message to the ATM using messaging protocols such as SMS, NFC, Bluetooth, or others.

The ATM communicates the token code to the Authentication System 20. If the transaction is approved by the Authentication System 20 and the ATM has adequate funds to pay the benefit to the Recipient (less any transaction fee), the ATM acts as the Agent 30 and dispenses cash to the Recipient 40. As noted above, the network operating the ATM may be paid a service fee which may be deducted from the unlocked funds being paid to the Recipient 40 or may be paid to the ATM network in a separate transaction.

The step of the Recipient 40 providing initial biometric data (biometric baseline) for use in subsequent remote authentication events may include the Recipient 40 providing the biometric data through the Recipient's own mobile telephone device. Thus, the impact of the characteristics of the mobile telephone device are captured with the biometric baseline data and do not impede the finding of a match on subsequent calls.

As noted above, the initial collection of the biometric baseline data may be done through use of a use code (such as a Social Security Number, Driver License Number, or other unique identifier) plus a PIN number for the enrollment process. Subsequent interactions with the Authentication System 20 could be done through use of just the user code (such as a Social Security Number).

As an alternative to exclusive reliance on the user code, some embodiments use an attribute of the telephone as the primary or exclusive way to identify the Recipient 40 to the Authentication System 20. The enrollment process may be set up to require use of a caller and/or device identification feature. The caller identification feature goes by a number of names including Caller Identification, Caller ID, “CID”, Calling Line Identification “CLID” Calling Number Identification “CNID” or Calling Line Identification Presentation “CLIP.” The device identifier may rely on a MAC address of the mobile device or some combination of the MAC address with a network identifier.

In most cases the entire benefit is released to the Recipient 40 upon authentication (for banked recipients) or through presentation of tokens to an Agent 30 (including No-Card operation at an ATM). But for unbanked Recipients 40 that receive a large benefit from a Payor 10, one alternative is to allow a Recipient 40 to receive a portion of the benefit in one transaction and another portion of the benefit in a series of subsequent transactions. One of skill in the art will appreciate that the Agent 30 including a network of ATMs must ensure that each request for provision of benefits to a Recipient 40 is authorized and does not cause the total amount of benefits provided to that Recipient 40 to exceed the total authorized benefit.

Thus, for example, a Recipient 40 of a pension may go through the authentication process in the beginning of a month and receive a token that may be used at ATM machines for the remainder of that month or until the total monthly pension has been provided to the Recipient 40. This requires additional information as the system must update the allowable benefit amount with much is being requested at each transaction and must check to see if additional funds are available. A token that may be used for several weeks to draw portions of the monthly benefit will need to have an expiration date that provides adequate time to obtain the benefits.

The general techniques for voice authentication through voice print comparison is described below. In one approach, the person being authenticated is asked to provide a biometric baseline by reciting a series of words or phrases, such as the twelve months of the year and the numbers one to ten, or in some cases random text phrases. The person may be asked to repeat each word or phrase several times. At this initial creation of the biometric baseline, the system checks to ensure that the quality of the voice data is sufficient for use. If the voice samples are not sufficient, then the person may be asked to repeat some or all of the process.

When the individual seeks to be authenticated, the individual is asked to recite a random sequence of a subset of several words or phrases from the previous list. Perhaps for one authentication session it might be March Two Seven November. The voice output from the person seeking authentication is matched against the biometric baseline. By using random subsets of the set of words, this process makes it difficult for even the true recipient to pre-record all possible sequences of words. The choice March Two Seven November was one of 22*21*20*19 choices (assumes that the choices from 22 possible words are made without replacement). Thus, even if a Recipient wanted to leave to a relative or a friend a set of voice recordings so that the relative or friend could continue to collect funds after the Recipient had died or moved away, this would not be practical.

Voice authentication is a two-tailed test. There is always some risk of a false positive (authenticating an imposter). The risk of a false yes is sometimes called a False Acceptance Rate, or “FAR.” However, as the voice authentication process works with the nuances of the voice print, it is very difficult to fool. An imposter repeating the correct sequence of words (March Two Seven November) would have only a tiny chance of obtaining a false positive.

An acceptable FAR may be 1 in 10,000. Setting the FAR too high results in an increase in false negatives (denying authentication to a true Recipient), referred to as a False Rejection Rate, or “FRR.” One can reduce the risk of a false positive by asking borderline performers to provide a PIN or answer a question. Designers may seek to have a FRR in the range of 1 in 200 to 1 in 50. Some of the FRR errors may come in part from temporary illnesses such as throat infections. Waiting a few days and retrying may be adequate if the failure was due to a transitory problem such as laryngitis or some other illness that grossly impacts sound quality.

Some alternatives use multiple verifiers, preferably using different verifier design algorithms. The robustness and security of the decision on authentication is enhanced since each verifier uses different algorithm for decision. Using different algorithms is useful in reducing the risk of error (FAR or FRR). For example is that some verifiers are good in noise reduction while others have support for cross channel, therefore a combination of different algorithms makes any one source of error less of a factor during the authorization process.

The voice print may be passed to the series of verifiers at the same time (in parallel rather than sequential) so that each verifier comes with a decision on the authentication and decide whether it is successful or failure. Based on the vote of each verifier the majority vote counts and thus the voice print is marked as successfully authenticated or otherwise.

In most cases, the thresholds are set with an upper level and a lower level. If the authentication process calculates its score to be below the lower threshold, the person is immediately rejected. If the score is above the upper threshold, the person is immediately accepted. However a score between the two means there is a match, but the match is not considered “good enough” to authorize payments. At this point and based on value for number of tries parameter, the system may ask the user to try again. Or, a borderline performer can be allowed access (e.g., to get payments) by combining other defined ID parameters such as answers to secret questions, a PIN, or other ID information.

For Recipients that are enrolled for an extended number of years, it may be useful to used Dynamic Speaker Adaptability (DSA) which tracks gradual variations in the user's voice during each authentication and modifies the stored baseline over time. Having a process to periodically update the biometric baseline over time will reduce the number of incidents where a legitimate recipient fails a biometric authentication and either needs to wait a few days to retry or has to travel to the payor to present proof of identity some other way and then provide a new biometric baseline.

In an additional variation, the voice authentication system may use a set of word pairs of any sort rather than the numbers and months as suggested above. Each word pair would be provided to the Recipient during the collection of baseline data and the Recipient would provide several samples of each word pair.

While it is expected that those using various teachings of the present disclosure will rely at least in part on agents that are not employees of the Payor 10, this is not a requirement. The network of agents could include or may exclusively contain employees of the Payor 10. Thus, employees of the payor at satellite offices convenient to a recipient could be used to make the benefit transfer while leaving to the Authentication System 20 the tasks of reliable authentication of the recipient and possibly even maintaining records on the use of the program.

While the example provided above assumes that the Recipient 40 seeks the voice authentication before traveling to the Agent's facility, this is not required. The Recipient 40 may, for example, use a mobile telephone or other equipment at the Agent's facility to perform the voice authentication. Without the use of the Recipient's caller identification information from the Recipient's mobile telephone, the Authentication System 20 may use a recipient user code such as a Social Security number other identification code to match the Recipient 40 seeking benefit transfer using the Agent's equipment and the Recipient's biometric baseline.

While the use of a mobile telephone is useful to receive an authorization token so that the authorization token can be carried to the agent (including an ATM), the processes described herein may be implemented without use of a mobile telephone. For example, a Recipient may use a “text only” device such as a pager, or in some cases a landline telephone or a facsimile machine.

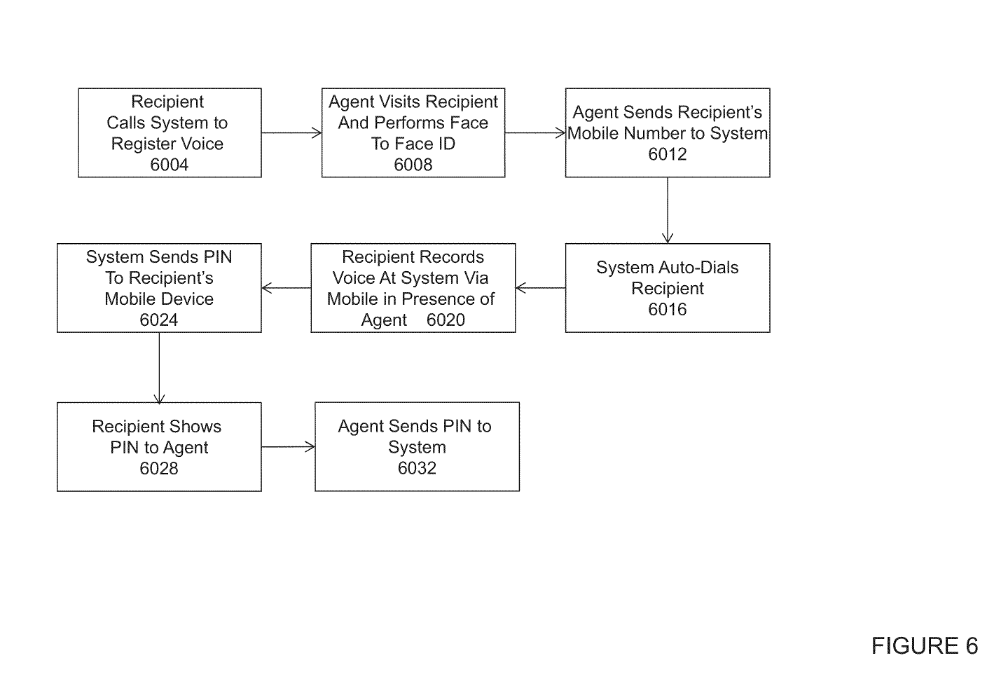

Referring now to FIG. 6, an alternate process for enrolling potential recipients into a benefit payment plan is illustrated. Initially, a potential recipient calls into the system and registers his voice by recording a baseline sample as described above (STEP 6004). The payor then dispatches an agent to the physical location of the recipient (or they meet in a mutually convenient location) where the agent identifies the recipient face-to-face using standard identification methods such as the presentation of a driver's license, passport, military ID, or other form of identification (STEP 6008). The agent then transmits a mobile number associated with the recipient to the system using her mobile device (which is known to the system to be authentic and secure) (STEP 6012) such that system can associate the recipient's benefit records with his mobile number. The system then auto-dials the recipient using the stored mobile number (STEP 6016), such that the recipient can answer the call in the presence of the agent. The recipient records another voice print using his device while in the physical presence of the agent (STEP 6020). In response, the system sends a PIN (typically a randomly generated alphanumeric string) to the recipient's mobile device using SMS or other messaging techniques (STEP 6024). The recipient shows the PIN to the agent, and the agent keys the PIN into her device and sends it back to the system for confirmation. As a result, the system is certain that the recipient is who they say they are, and that the voice print on file is in fact from that individual.

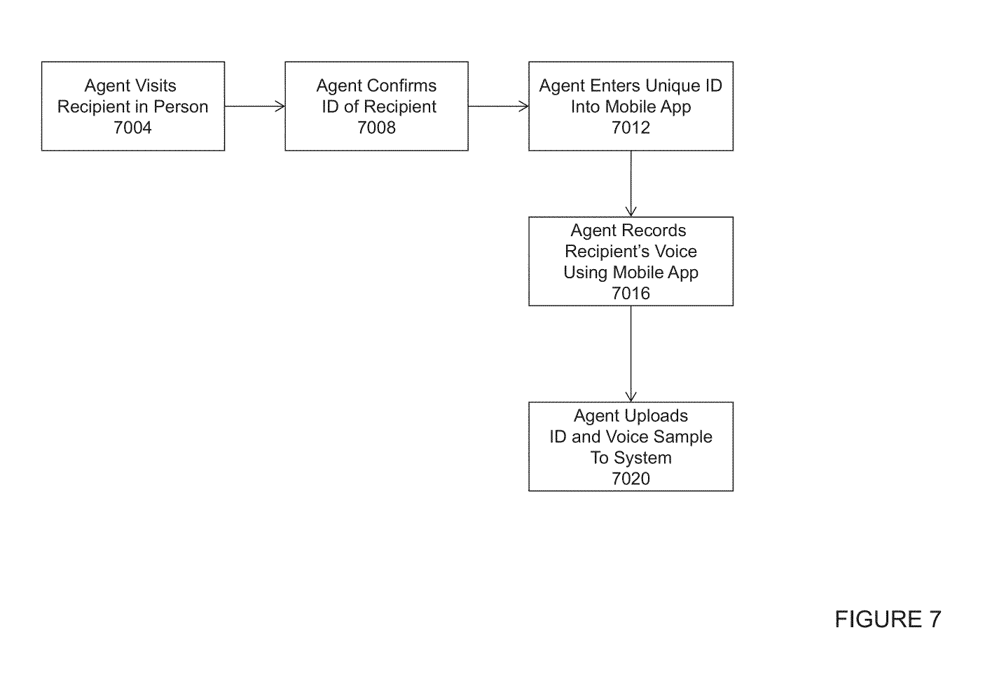

In another alternative a mobile application may be provided to the agent for effecting enrollment. Referring to FIG. 7, the agent visits the recipient in person (STEP 7004) and confirms their identity, as described above (STEP 7008). Using the mobile application on her device which, in some instances, may be issued by the payor, the agent enters a unique ID associated with the recipient (STEP 7012). At the same time, or very shortly thereafter, but still while in the presence of the recipient, the agent records the recipient's voice print using the mobile app on her device (STEP 7016). The agent then uploads the unique ID and voice print to the system (STEP 7020), such that the ID and voice print are uniquely associated with that recipient.

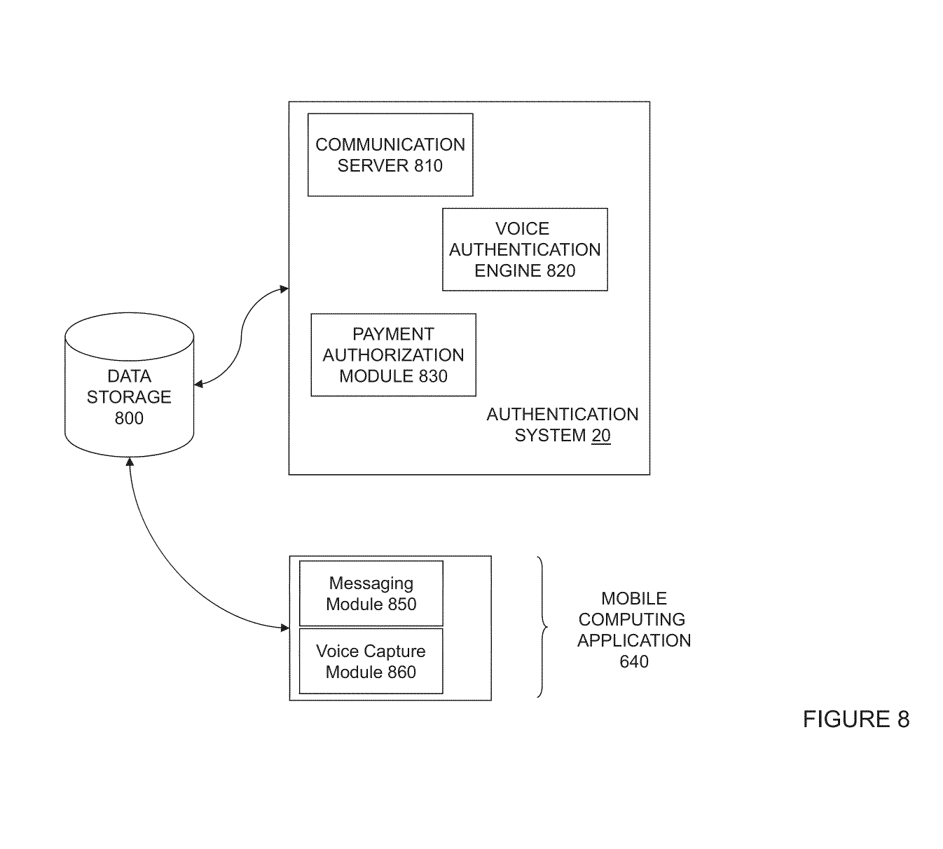

Referring now to FIG. 8, the authentication system 20 described above may be implemented on one or more hardware devices comprising sufficient memory and processing resources. For example, the voice capture, storage, authentication and comparison processes may each be implemented as functional modules being executed on one or more servers. An exemplary server comprises hardware CPU(s), operatively connected to hardware/physical memory and input/output (UO) interface. Hardware/physical memory may include volatile and/or non-volatile memory. The memory may store one or more instructions to program the CPU to perform any of the functions described herein. The memory may also store one or more application programs. Separate data storage server(s) 800 may also be used to store recipient information, voice prints, and benefit payment information.

The processes and functions may be allocated to one or more computational modules that are implemented as computer-executable instructions on the server. For example, a communication module 810 may be used to manage communications between the various constituents that interact with the system 20. Examples of such modules include the Apache HTTP server, IBM WebSphere, and Microsoft's Windows Server. The voice authentication and comparison tasks may be implemented by a voice authentication engine 820. A payment authorization module 830 tracks recipient eligibility, payment status, and account balances.

Although examples provided herein may have described the modules as residing on a single server, it should be appreciated that the functionality of these components can be implemented on any larger number of computers in a distributed fashion. Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks. Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above. The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish a relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

One skilled in the art will realize the invention may be embodied in other specific forms without departing from the spirit or essential characteristics thereof. The foregoing embodiments, together with the attached exhibits, are therefore to be considered in all respects illustrative rather than limiting of the invention described herein.

1. A system for authenticating the identity of a recipient of a benefit from a payor, the system comprising:
a storage server for storing in a physical memory sets of baseline biometric files, each set of baseline biometric files being captured during an enrollment process and associated with a set of qualified recipients of a series of benefit transfers from a payor, the set including a primary benefit recipient, and the baseline biometric files including a voice print for use in voice authentication of the qualified recipients; and
a processor for executing stored computer-executable instructions that, when executed implement a voice authentication engine that: (i) compares a current voice print obtained from a recipient requesting authorization and access to at least one of the series of benefit transfers with the biometric baseline file for requesting recipient, and (ii) upon determining the current voice print matches with the biometric baseline file associate with the requesting recipient within an acceptable threshold, creates an authorization token comprising an authorization code and communicate the authorization token to the requesting recipient.

2. The system of claim 1 further comprising stored computer-executable instructions that, when executed on the processor implement a payment authorization module that (i) receives a request from a remote agent for approval for payment of at least one of the benefit transfers to the requesting recipient, the request including the authorization token, and (ii) authorize transfer of funds to the remote agent pursuant to the benefit transfer if the authorization token is confirmed as authentic.

3. The system of claim 2 wherein the remote agent comprises an automated teller machine that receives the authentication code from the requesting recipient seeking payment of the funds that originate from the payor and the payment authorization module authorizes the transfers for the requesting recipient to an entity that operates the automated teller machine.

4. The system of claim 2 wherein the remote agent comprises a third party account holder acting on behalf of the requesting recipient.

5. The system of claim 4 wherein the payment authentication module reserves a portion of the benefit for payment to the third party account holder as compensation for facilitating the transfer of funds to the requesting recipient.

6. The system of claim 2, wherein the request from the remote agent comprises a request for partial payment of the benefit transfer to the requesting recipient.

7. The system of claim 1 wherein the biometric baseline file for the requesting recipient is associated with a parameter that uniquely identifies a mobile telephone used by the particular recipient for voice authentication.

8. The system of claim 1 wherein the authorization token is communicated to the requesting recipient by sending the authentication token to a mobile telephone associated with the recipient.

9. The system of claim 1 wherein the set of qualified recipients comprises one or more alternative recipients, and the requesting recipient is identified as an alternative recipient, thus facilitating payment of the benefit directly to the alternative recipient.

10. The system of claim 2 wherein the payment authorization module receives recipient information regarding the eligibility of the requesting recipient to receive the benefit, and upon receiving the request from the requesting recipient, determines whether the requesting recipient remains eligible to receive the benefit.

11. The system of claim 2 wherein the payment authorization module checks to ensure that the requesting recipient has not already obtained a benefit transfer which precludes obtaining the requested benefit transfer.

12. The system of claim 1 wherein the authentication token authorization code expires after a specific time period such that the expired authentication code cannot be used to obtain a benefit transfer after expiration.

13. The system of claim 1 wherein the voice authentication engine replaces the baseline biometric sample with the current voice print in the storage module, thereby updating the baseline biometric sample with a more recent voice print to be used as a subsequent baseline biometric sample.

14. A method for authenticating the identity of a recipient of a benefit from a payor, the method comprising:
providing a storage server for storing sets of baseline biometric files, each set of baseline biometric files being captured during an enrollment process and associated with a set of qualified recipients of a series of benefit transfers from a payor, the set including a primary benefit recipient, and the baseline biometric files including a voice print for use in voice authentication of the qualified recipients; and
providing a set of computer-executable instructions that, when executed by a processor, (i) compares a current voice print obtained from a recipient requesting authorization and access to at least one of the series of benefit transfers with the biometric baseline file for the requesting recipient, and (ii) upon determining the current voice print matches with the biometric baseline file associate with the requesting recipient within an acceptable threshold, creates an authorization token comprising an authorization code and communicate the authorization token to the requesting recipient.

15. The method of claim 14 wherein the stored computer-executable instructions, when executed on the processor, further (i) receives a request from a remote agent for approval for payment of at least one of the benefit transfers to the requesting recipient, the request including the authorization token, and (ii) authorize transfer of funds to the remote agent pursuant to the benefit transfer if the authorization token is confirmed as authentic.

16. The method of claim 15 wherein the remote agent comprises an automated teller machine that receives the authentication code from the requesting recipient seeking payment of the funds that originate from the payor and authorizing the transfer for the requesting recipient to an entity that operates the automated teller machine.

17. The method of claim 15 wherein the remote agent comprises a third party account holder acting on behalf of the requesting recipient.

18. The method of claim 17 wherein the stored computer-executable instructions, when executed on the processor, further reserve a portion of the benefit for payment to the third party account holder as compensation for facilitating the transfer of funds to the requesting recipient.

19. The method of claim 14, wherein the request from the remote agent comprises a request for partial payment of the benefit transfer to the requesting recipient.

20. The method of claim 14 wherein the biometric baseline file for the requesting recipient is associated with a parameter that uniquely identifies a mobile telephone used by the particular recipient for voice authentication.

21. The method of claim 14 wherein the stored computer-executable instructions, when executed on the processor, further communicate the authorization token to the requesting recipient by sending the authentication token to a mobile telephone associated with the recipient.

22. The method of claim 14 wherein the set of qualified recipients comprises one or more alternative recipients, and the requesting recipient is identified as an alternative recipient, thus facilitating payment of the benefit directly to the alternative recipient.

23. The method of claim 14 wherein the stored computer-executable instructions, when executed on the processor, further receives recipient information regarding the eligibility of the requesting recipient to receive the benefit, and upon receiving the request from the requesting recipient, determines whether the requesting recipient remains eligible to receive the benefit.

24. The method of claim 14 wherein the stored computer-executable instructions, when executed on the processor, further checks to ensure that the requesting recipient has not already obtained a benefit transfer which precludes obtaining the requested benefit transfer.

25. The method of claim 14 wherein the authentication token authorization code expires after a specific time period such that the expired authentication code cannot be used to obtain a benefit transfer after expiration.

26. The method of claim 14 wherein upon determining the current voice print does not match the biometric baseline file associate with the requesting recipient within an acceptable threshold, facilitating a telephone connection between the requesting recipient and a call center.

27. The method of claim 14 wherein the baseline biometric files comprise a text-dependent phrase and the requesting recipient provides a voice sample including the text-dependent phrase and additional phrases intermixed within the text-dependent phrase, and wherein the stored computer-executable instructions, when executed on the processor, further extract the text-dependent phrase from the additional phrases and compares the extracted text-dependent phrase to the baseline biometric files.

28. The method of claim 27 wherein the stored computer-executable instructions, when executed on the processor, further compares the additional phrases to the text-dependent phrases to confirm speaker consistency throughout the received voice sample.

29. A method for validating the identity of a recipient of a benefit payment from a payor, the method comprising:
receiving via a telephone network, a voice sample of the recipient and storing the received voice sample in a data storage server;
while in the presence of the recipient, an agent of the payor confirming the identity of the recipient and sending a message to the data storage server, the message including a mobile telephone number registered to the recipient;
automatically calling the mobile telephone number registered to the recipient and receiving a second voice sample of the recipient while the recipient is in the presence of the agent of the payor;
transmitting a unique identifier to the mobile telephone number registered to the recipient; and
receiving a message including the unique identifier from the agent of the payor.

30. A system for remotely enrolling a recipient of a benefit payment with a system for validating the recipient's identity an authorizing payment to the recipient, the system comprising:
a processor for executing computer-executable instructions;
memory for storing computer readable instructions, that when executed by the processor implements an application operational on a mobile computing device whereby a user of the application (i) enters a unique identification number associated with an intended recipient of a benefit payment, (ii) records a voice sample of the intended recipient of the benefit payment, and (iii) transmits the unique identification number and voice sample from the mobile computing device to a central server, thus enrolling the intended recipient as an authorized recipient of benefit payments.

31. The system of claim 30 wherein the unique identification number comprises a social security number.

32. The system of claim 30 wherein the voice sample comprises text-specific spoken phrases.

33. The system of claim 30 wherein the voice sample comprises random, text-independent spoken phrases.
